(19) United States
(12) Patent Application Publication
(10) Pub. No.: US 2009/0232583 A1
(43) Pub. Date: Sep. 17, 2009

(54) WHITEBOARD-MARKER HAVING ARCH-SHAPED HOUSING

(76) Inventor: Seong Ho Hong, Seoul (KR)

Correspondence Address: WEINER & BURT, P.C., 635 N US-23, POB 186, HARRISVILLE, MI, 48740, US

(21) Appl. No.: 11/909,092

(22) PCT Filed: Mar. 17, 2006
(86) PCT No.: PCT/KR06/00993

§ 371 Date: Sep. 19, 2007

(51) Int. Cl. B43K 5/00

(52) U.S. Cl. 401/202

(57) ABSTRACT

A whiteboard marker having an arch-shaped housing is disclosed. The whiteboard marker of the present invention includes an ink tube (11a, 11b), a housing (13), in which the ink tube is housed, a front cap (17a, 17b), which is coupled to the housing, a penpoint (15a, 15b), which is fastened to the front cap, and a lid (19a, 19b). The present invention is characterized in that the housing is formed to have an arch shape, so that ink flows towards penpoints due to osmotic pressure and to gravity. Furthermore, the whiteboard marker may comprise first and second marker units. Each of the first and second marker units includes a front cap, which has a penpoint and is coupled to each of opposite ends of the arch-shaped housing, an ink tube, which is housed in the housing such that it contacts the penpoint, and a lid, which covers the front cap. The present invention allows a user to alternately use the whiteboard marker in opposite directions and is advantageous in that ink, which is contained in the ink tube, can be completely used.

### TECHNICAL FIELD

The present invention relates, in general, to whiteboard markers which make it possible to efficiently and completely use ink, which is contained in ink tubes provided in housings, and, more particularly, to a whiteboard marker, a housing of which has an arch shape so that ink contained in ink tubes can be completely used with the help of gravity without any portion remaining.

### BACKGROUND ART

In the case of the conventional art, in which users write or draw on blackboards with chalk, there is a problem of injuring the user's health due to the large amount of dust. Recently, in an effort to overcome the above-mentioned problem, whiteboards with whiteboard markers, which allow the user to write and draw with ease, have been widely used in places such as offices, schools and educational institutions, in which seminars are conducted.

Typically, in such a conventional whiteboard marker, an ink tube, which is filled with ink, is inserted in a housing of the whiteboard marker such that the ink tube contacts a penpoint coupled to the front end of the housing and, thereafter, the housing is airtightly sealed. When writing or drawing, the ink is supplied to the penpoint by osmotic pressure.

This whiteboard marker has an advantage in that the user can easily write on the coated whiteboard with the whiteboard marker using water-based ink and easily erase it, thus being convenient for the user. However, the conventional whiteboard marker has some structural problems. To solve the problems, various techniques have been proposed.

In detail, the whiteboard-marker has a characteristic problem in that, because water-based ink having high volatility is used, the ink easily evaporates. To mitigate this problem, a housing of a whiteboard marker is sealed after an ink tube is inserted into the housing, and a lid for covering the penpoint is provided. However, the whiteboard marker having the above-mentioned construction has a disadvantage in that it cannot be recycled after the ink has been completely used. To solve this problem, various refillable whiteboard markers were proposed and have been commercialized at present.

Furthermore, in the typical whiteboard marker, because the ink tube provided in the housing has a single color of ink, when it is necessary to write or draw on the whiteboard in various colors, several whiteboard markers must be prepared depending on the number of required colors. To solve this problem, a whiteboard marker, in which penpoints are provided on respective opposite ends of a housing of the whiteboard marker and ink tubes filled with different colors of ink are housed in related parts of the housing, was invented, and various whiteboard markers having the above-mentioned structure have been produced.

As such, the above-mentioned whiteboard markers solve some of the problems experienced with the conventional arts and exhibit the desired effects. However, none of the above-mentioned whiteboard markers solves the problem in that the ink contained in the ink tube provided in the housing is not completely used. In other words, the conventional whiteboard markers have the structural limits preventing complete use of ink contained in the ink tube.

As well known to those skilled in the art, the typical whiteboard markers have structures such that an ink-storing substance is provided in the ink tube housed in the housing so that ink is supplied to the penpoint, which is coupled to the front cap provided on the end of the housing, both by osmotic pressure occurring in the ink storing substance and by gravity acting on the ink. Such a structure is also applied to a water-based pen, an oil-based pen or a highlighter. In the case of the water-based pen, the oil-based pen or the highlighter, because the user mainly uses it on a table, the penpoint of the pen mainly faces downwards when used. Therefore, ink can be completely used thanks to gravity acting thereon. However, in the case of the whiteboard marker, which is typically used on a whiteboard attached on a wall, because the penpoint thereof mainly faces upwards when used, gravity acts in a backward direction of the whiteboard marker. Therefore, there is a problem in that contained ink may not be completely used. In this case, although ink remains in the ink tube provided in the housing of the whiteboard marker, the user may think that no more ink remains, because ink is not discharged when used, and discard it. That is, the whiteboard marker having the I-shaped housing is problematic in that, because ink is not discharged despite the fact that some remains, the marker may be discarded.

### DISCLOSURE OF INVENTION

### TECHNICAL PROBLEM

Accordingly, the present invention has been made keeping in mind the above problems occurring in the prior art, and an object of the present invention is to provide a whiteboard marker which has a structure such that ink, which is contained in an ink tube provided in a housing, can be completely used. Moreover, another object of the present invention is to provide a whiteboard marker which is more economically and conveniently used, taking advantage of the above-mentioned structure.

### TECHNICAL SOLUTION

In order to accomplish the above objects, the present invention provides a whiteboard marker, which includes an ink tube to contain ink therein; a housing, in which the ink tube is housed; a front cap coupled to the housing; a penpoint fastened to the front cap; and a lid. The present invention is characterized in that the housing is formed in an arch shape, so that ink contained in ink tubes always flows towards penpoints due to osmotic pressure and to gravity. Furthermore, the whiteboard marker of the present invention may comprise a first marker unit and a second marker unit.

Each of the first and second marker units includes: a front cap having a penpoint and coupled to each of opposite ends of the housing; an ink tube housed in the housing such that the ink tube is in contact with the penpoint; and a lid covering the front cap.

Thus, the present invention allows a user to alternately use the whiteboard marker in opposite directions.

Here, the ink tubes, the front caps, the penpoints and the lids are well-known components, therefore further explanation is deemed unnecessary.

The housing has a cylindrical or angled shape, which is open at opposite ends thereof, and is basically formed in an integrated structure. The method of housing the ink tubes in the integrated housing and coupling the front caps, holding the penpoints, to the housing is based on a well known technique. In this case, to prevent the ink tubes, which are housed in the housing, from undesirably moving, it is preferable that the circumferential inner surface of the housing be in close contact with the circumferential outer surfaces of the ink tubes, and support ribs may be used.

Meanwhile, the housing may be formed in an integrated structure or, alternatively, it may be formed in a separable structure. In the case of the integrated housing, the whiteboard marker is manufactured such that the housing is integrated with other components. Thus, after ink contained in the ink tubes has been completely used, the whiteboard marker is discarded because it cannot be recycled. However, in the case that the opposite parts of the housing are separably coupled to each other using the connection member, when ink, which is contained in the ink tube of either the first marker unit or the second marker unit, has been completely used, the whiteboard marker can be recycled by removing the associated part from the connection member and replacing it with a new marker unit having an ink tube filled with ink. As such, in the case of the separable type housing, separate replacement marker units, which can be removably coupled to the connection unit, must be manufactured and sold separately.

Furthermore, the connection member has a cylindrical or angled shape, which is open at the opposite ends thereof, and is constructed such that the first marker unit and the second marker unit are removably coupled thereto at the peak position of the arch-shaped housing. Preferably, the connection member forms the peak part of the housing in an appropriate length such that ink, which is contained in the ink tubes provided in the first and second marker units, always flows towards the penpoints when used.

Preferably, the housing and the ink tubes are made of transparent material to allow a user to observe whether ink contained in the ink tubes housed in the housing, is completely used.

Meanwhile, the housing is configured such that, when viewed in a plan view, the front caps of the first and second marker units are disposed in the same linear line and are spaced apart from each other at 180°. However, this is only one example. Alternatively, the housing may be configured such that it has three ends so that the three ends form a first marker unit, a second marker unit and a third marker unit. That is, the housing has an arch shape and may be configured such that, when viewed in a plan view, the ends of the three marker units are spaced apart from each other at 120°.

Furthermore, preferably, the lids of the whiteboard marker are planar at closed ends thereof, such that the whiteboard marker can be stood upright so as to maximally take advantage of the characteristics of the present invention when putting down the whiteboard marker for a moment during use or when storing it after use.

### ADVANTAGEOUS EFFECTS

As described above, in a whiteboard marker of the present invention, a housing thereof has an arch shape, so that ink contained in ink tubes always flows towards penpoints, which are disposed at lower positions, due to osmotic pressure and to gravity. Therefore, the present invention is advantageous in that the ink can be completely used without waste.

Furthermore, because ink contained in the ink tubes always flows towards the penpoints, even if the whiteboard marker is used for a relatively long time at one time, the ink can be discharged without interruption. Thus, there is an advantage in that the time for which the whiteboard marker can be used is increased.

As well, in the case that the housing is formed in a separable structure, when ink contained in one ink tube has been completely exhausted, only a part of the whiteboard marker need be replaced with a new one, and the entire whiteboard marker need not be replaced. Moreover, different colors of ink may be contained in the ink tubes, which are housed in related parts of the housing. Accordingly, the single whiteboard marker of the present invention solves an inconvenience of the conventional art in which, when various colors are required, a user must hold several whiteboard markers having various colors.

### BRIEF DESCRIPTION OF THE DRAWINGS

FIG. 1 is a perspective view of a whiteboard marker, according to an embodiment of the present invention;

FIG. 2 is a front view of the whiteboard marker according to the present invention;

FIG. 3 is an exploded view of the whiteboard marker of FIG. 2; and

FIG. 4 is a plan view of a whiteboard marker, according to another embodiment of the present invention.

### DESCRIPTION OF THE ELEMENTS IN THE DRAWINGS

11a: first ink tube 11b: second ink tube

13: housing 13a: first marker unit

13b: second marker unit 13c: third marker unit

15a: first penpoint 15b: second penpoint

17a: first front cap 17b: second front cap

19a: first lid 19b: second lid

20: closed end of lid 21: connection member

23a: first external threaded part 23b: second external threaded part

25a: first internal thread 25b: second internal thread

### BEST MODE FOR CARRYING OUT THE INVENTION

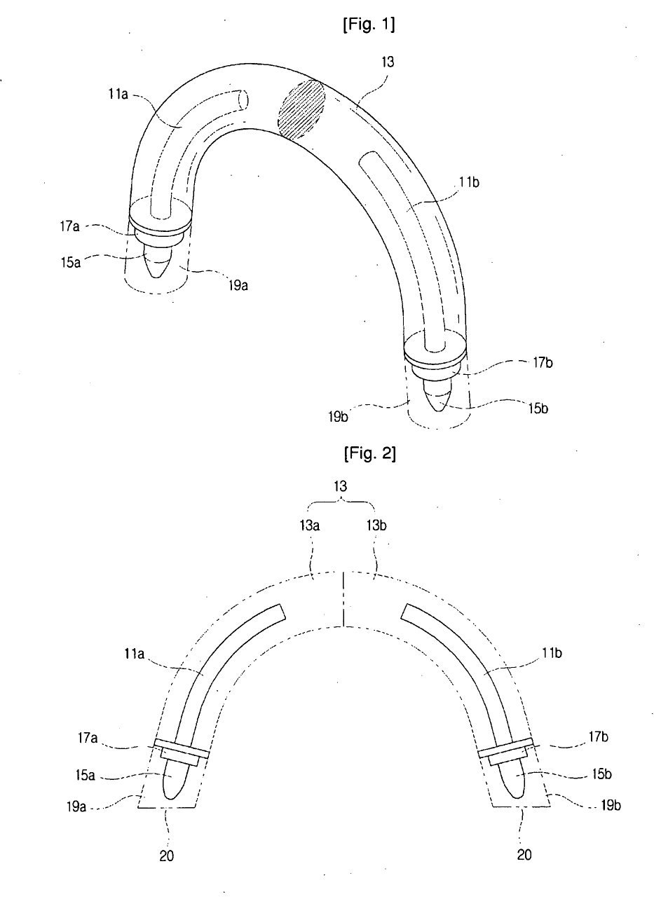

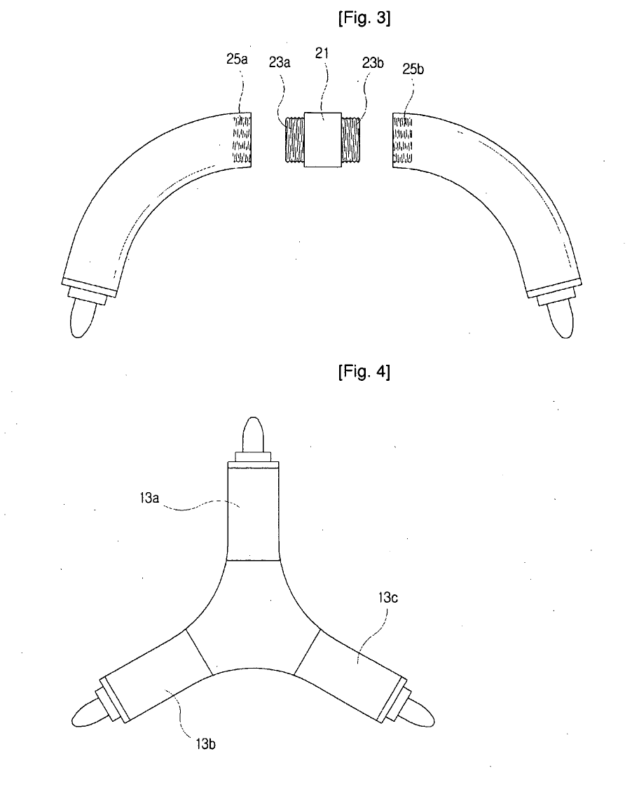

FIG. 1 is a perspective view of a whiteboard marker, according to an embodiment of the present invention. FIG. 2 is a front view of the whiteboard marker according to the present invention. FIG. 3 is an exploded view of the whiteboard marker of FIG. 2. FIG. 4 is a plan view of a whiteboard marker, according to another embodiment of the present invention.

The whiteboard marker of the present invention includes a housing 1, ink tubes 11a and 11b, which are provided in the housing 1, front caps 17a and 17b, which are coupled to the housing 1, penpoints 15a and 15b, which are respectively coupled to the front caps 17a and 17b, and lids 19a and 19b. Here, the housing 13 has an arch shape. Therefore, as shown in FIG. 1, the ink tubes 11a and 11b, which contact the penpoints 15a and 15b coupled to the front caps 17a and 17b, can maintain the state of being stood upright, so that ink contained in the ink tubes 11a and 11b always flows towards the penpoints 15a and 15b, which are provided at lower positions, due to osmotic pressure and to gravity.

As such, because the housing 13 of the whiteboard marker is an arch shape, ink, which is contained in the ink tubes 11a and 11b, can be completely used. Furthermore, as shown in FIG. 2, using the characteristics of the whiteboard marker having the arch-shaped housing 13, the present invention comprises first and second marker units 13a and 13b, which are provided in opposite directions. In detail, as shown in FIG. 2, when viewed in a front view, the whiteboard marker is sectioned into left and right sides, so that the first marker unit 13a is provided on the left side, and the second marker unit 13b is provided on the right sides. In this case, the first ink tube 11a and the second ink tube 11b are housed in respective parts of the housing 13 which constitute the first and second marker units 13a and 13b. As well, the first penpoint 15a and the second penpoint 15b are respectively coupled to the first front cap 17a and the second front cap 17b which are provided on the respective ends of the housing 13, such that the first and second penpoints 15a and 15b respectively contact the first and second ink tubes 11a and 11b. In addition, the first and second lids 19a and 19b are fitted over the respective front caps to cover them.

Due to this construction, taking advantage of the characteristics of the whiteboard marker having the arch-shaped housing, the whiteboard marker can be used in opposite directions. As required, different colors of inks may be contained in the first ink tube 11a and the second ink tube 11b. For example, black ink may be contained in the first ink tube 11a and blue ink may be contained in the second ink tube 11b, such that they can be alternately used, as required. As well as the above-mentioned colors, other colors of ink may be contained in the ink tubes.

Furthermore, as shown in FIG. 1, the housing 13 has an open cylindrical shape or an open angled shape. To prevent the ink tubes 11a and 11b from undesirably moving, it is preferable that the circumferential inner surface of the housing 13 be in close contact with the circumferential outer surfaces of the ink tubes 11a and 11b. Furthermore, although not shown in the drawings, support ribs may be used to achieve the above-mentioned purpose.

Meanwhile, in the whiteboard marker of the present invention, the housing 13 may have an integrated structure or, alternatively, may have a separable structure. In detail, FIG. 3 is an exploded view of the housing. As shown in FIG. 3, to form the housing 13 having a separable structure, a connection member 21 is preferably provided in the longitudinal direction of the housing.

The connection member 21 serves to couple the first marker unit 13a and the second marker unit 13b to each other. Preferably, the connection member 21 includes a first external threaded part 23a, which is inserted into the rear end of the first marker unit 13a, and a second external threaded part 23b, which is inserted into a rear end of the second marker unit 13b. To couple the first and second marker units 13a and 13b to each other using the connection member 21, as shown in FIG. 3, the first and second external threaded parts 23a and 23b are provided on the connection member 21, and a first internal thread 25a and a second internal thread 25b are respectively formed on circumferential inner surfaces of the rear ends of the first and second marker units 13a and 13b, so that the first and second external threaded parts 23a and 23b respectively engage with the first and second internal threads 25a and 25b, thus preventing the first and second marker units 13a and 13b from being undesirably separated from the connection member 21.

Furthermore, in the reverse manner, the first and second external threaded parts 23a and 23b and the first and second internal threads 25a and 25b may be respectively formed on the first and second marker units 13a and 13b and the connection member 21. Preferably, not shown in the drawings, a partition wall may be provided in a medial position on the inner surface of the connection member 21 to divide it into a region related to the first marker unit 13a and a region related to the second marker unit 13b.

In this case, the connection member 21 has a cylindrical or angled shape, which is open at opposite ends thereof, and is constructed such that the first marker unit 13a and the second marker unit 13b are removably coupled thereto at the peak position of the arch-shaped housing 13. Preferably, the connection member 21 forms the peak part of the housing 13 in an appropriate length such that ink, which is contained in the ink tubes 11a and 11b provided in the first and second marker units 13a and 13b, always flows towards the penpoints 15a and 15b when used.

Meanwhile, in the case that the housing 13 of the whiteboard marker of the present invention is formed in the separable structure, it is preferable that separate replacement marker units, which can be removably coupled to the connection unit 21, be manufactured and sold separately. These replacement marker units must have the same construction as that of the first or second marker unit. In detail, each replacement marker unit includes a housing, an ink tube, which is provided in the housing, a front cap, which is coupled to the housing, a penpoint, which is held by the front cap, and a lid, which covers the front cap. Furthermore, the replacement marker unit preferably includes a first internal thread 25a or a second internal thread 25b which is formed in the circumferential inner surface of the housing thereof and engages with the first external threaded part 23a or the second external threaded part 23b of the connection member 21. As well, preferably, a protective cap is removably provided on the rear end of the replacement marker to prevent ink contained in the ink tube from evaporating during a production distribution process. In addition, preferably, the replacement marker units have various colors, so that a user can selectively replace the exhausted marker unit with a new one having a desired color, as required.

Therefore, when ink, which has been contained in the ink tube of one of the first and second marker units, is completely exhausted, the user can remove the exhausted marker unit from the connection member and, thereafter, replace it with a new one having an ink tube filled with ink.

As such, the whiteboard marker of the present invention is characterized in that the housing 13 is formed in an arch-shape. The housing 13 is configured such that, when viewed in a plan view, the front caps 17a and 17b of the first and second marker units 13a and 13b are disposed in the same linear line and spaced apart from each other at 180°. However, this is only one example. Alternatively, the housing 13 may be configured such that it has three ends so that the three ends form a first marker unit 13a, a second marker unit 13b and a third marker unit 13c. That is, the housing 13 has an arch shape and may be configured such that, when viewed in a plan view, the ends of the three marker units are spaced apart from each other at 120°.

FIG. 4 is a plan view of a whiteboard marker, according to another embodiment of the present invention. As shown in FIG. 4, in this embodiment, an arch-shaped housing has three ends which face in three directions.

That is, taking advantage of the characteristics of the whiteboard marker having the arch-shaped housing, as shown in FIG. 4, the whiteboard marker is constructed such that a first marker unit 13a, a second marker unit 13b and a third marker unit 13c are oriented in three directions. In this case, a first ink tube 11a, a second ink tube 11b and a third ink tube (not shown) are housed in the housing 13 at positions corresponding to the first marker unit 13a, the second marker unit 13b and the third marker unit 13c. A first penpoint 15a, a second penpoint 15b and a third penpoint (not shown) are respectively coupled to a first front cap 17a, a second front cap 17b and a third front cap (not shown) which are provided on the respective ends of the housing 13, such that the first penpoint 15a, the second penpoint 15b and the third penpoint (not shown) respectively contact the first ink tube 11a, the second ink tube 11b and the third ink tube (not shown). In addition, a first lid 19a, a second lid 19b and a third lid (not shown) are fitted over the respective front caps to cover them.

Due to this construction, taking advantage of the characteristics of the whiteboard marker having the arch-shaped housing, the whiteboard marker can be used in three directions. As required, different colors of ink may be contained in the first ink tube 11a, the second ink tube 11b and the third ink tube (not shown). For example, black ink may be contained in the first ink tube 11a, blue ink may be contained in the second ink tube 11b, and red ink may be contained in the third ink tube (not shown), so that they can be alternately used, as required.

Furthermore, even in the case of the three directional whiteboard marker, the housing 13 may be formed into a separable structure. Even in this case, it is preferable that a connection member be provided to form the housing 13 into a separable structure. The connection member has a cylindrical or angled shape, which is open in three directions, and is constructed such that the first marker unit 13a, the second marker unit 13b and the third marker unit 13c are removably coupled thereto at the peak position of the arch-shaped housing 13. Preferably, the connection member forms the peak part of the housing 13 in an appropriate length such that ink, which is contained in the ink tubes provided in the first, second and third marker units 13a, 13b and 13c, always flows towards the penpoints when used.

The connection member 21 serves to couple the first marker unit 13a, the second marker unit 13b and the third marker unit 13c together. Preferably, the connection member 21 includes a first external threaded part 23a, which is inserted into the rear end of the first marker unit 13a, a second external threaded part 23b, which is inserted into the rear end of the second marker unit 13b, and a third external threaded part (not shown), which is inserted into the rear end of the third marker unit 13c. To couple the first, second and third marker units 13a, 13b and 13c together using the connection member 21, the first external threaded part 23a, the second external threaded part 23b and the third external threaded part (not shown) are provided on the connection member 21, and a first internal thread 25a, a second internal thread 25b and a third internal thread (not shown) are respectively formed on circumferential inner surfaces of the rear ends of the first, second and third marker units 13a, 13b and 13c, so that the first threaded part 23a, the second external threaded part 23b and the third external threaded part (not shown) respectively engage with the first internal thread 25a, the second internal thread 25b and the third internal thread (not shown), thus preventing the first, second and third marker units 13a, 13b and 13c from being undesirably separated from the connection member 21.

Thanks to this construction, when ink which has been contained in the ink tube of one of the first and second marker units is completely exhausted, the user can remove the exhausted marker unit from the connection member and, thereafter, replace it with a new one having an ink tube filled with ink.

Meanwhile, in the integrated type or separable type whiteboard marker of the present invention, the lids 19a and 19b are preferably planar at closed ends 20 thereof such that the whiteboard marker can be stood upright so as to maximally take advantage of the characteristics of the present invention when putting down the whiteboard marker for a moment during use or when storing it after use. Furthermore, it is preferable that the housing and the ink tubes be made of transparent material to allow the user to observe whether ink, contained in the ink tubes housed in the housing, is completely used.

### INDUSTRIAL APPLICABILITY

As described above, in a whiteboard marker of the present invention, a housing thereof has an arch shape, so that ink contained in ink tubes always flows towards penpoints, which are disposed at lower positions, due to osmotic pressure and to gravity. Therefore, the present invention is advantageous in that ink can be completely used without waste.

Furthermore, because ink contained in the ink tubes always flows towards the penpoints, even if the whiteboard marker is used for a relatively long time at one time, the ink can be discharged without interruption. Thus, there is an advantage in that the time for which the whiteboard marker can be used is increased.

As well, in the case that the housing is formed to have a separable structure, when ink contained in one ink tube has been completely exhausted, only a part of the whiteboard marker need be replaced with a new one, but the entire whiteboard marker need not be replaced. Moreover, different colors of ink may be contained in the ink tubes, which are housed in related parts of the housing. Accordingly, the single whiteboard marker of the present invention solves an inconvenience of the conventional art in which, when various colors are required, a user must hold several whiteboard markers having various colors.

1. A whiteboard marker, comprising: an ink tube to contain ink therein; a housing, in which the ink tube is housed; a front cap coupled to the housing; a penpoint fastened to the front cap; and a lid, wherein the housing has an arch shape.

2. The whiteboard marker according to claim 1, comprising: a first marker unit and a second marker unit, each of the first and second marker units comprising: the front cap having the penpoint and coupled to each of opposite ends of the housing; the ink tube housed in the housing such that the ink tube is in contact with the penpoint; and the lid covering the front cap.

3. The whiteboard marker according to claim 1, wherein the housing is formed to have an integrated structure.

4. The whiteboard marker according to claim 1, wherein the housing comprises a connection member, so that the first marker unit and the second marker unit are removably coupled to each other through the connection member.

5. The whiteboard marker according to claim 2, wherein a closed end of each of the lids is planar such that the whiteboard marker having the arch-shaped housing is stood upright.

6. The whiteboard marker according to claim 1, comprising: a first marker unit, a second marker unit and a third marker unit which are formed in three directions, each of the first, second and third marker units comprising: the front cap having the penpoint and coupled to each of ends of the housing; the ink tube housed in the housing such that the ink tube is in contact with the penpoint; and the lid covering the front cap.

7. The whiteboard marker according to claim 1, wherein the housing is formed to have an integrated structure.

8. The whiteboard marker according to claim 1, wherein the housing comprises at a peak position thereof a connection member, so that the first marker unit, the second marker unit and the third marker are removably coupled to each other through the connection member.

9. The whiteboard marker according to claim 6, wherein a closed end of each of the lids is planar such that the whiteboard marker having the arch-shaped housing is stood uprightly.

10. The whiteboard marker according to claim 2, wherein the housing is formed to have an integrated structure.

11. The whiteboard marker according to claim 2, wherein the housing comprises a connection member, so that the first marker unit and the second marker unit are removably coupled to each other through the connection member.

12. The whiteboard marker according to claim 6, wherein the housing is formed to have an integrated structure.

13. The whiteboard marker according to claim 6, wherein the housing comprises at a peak position thereof a connection member, so that the first marker unit, the second marker unit and the third marker are removably coupled to each other through the connection member.
